(19) United States
(12) Patent Application Publication
(10) Pub. No.: US 2014/0326418 A1
(43) Pub. Date: Nov. 6, 2014

(54) Vehicle Window Shield for Optical Device

(71) Applicant: Nikolai L. Dobrescu, Ely, NV (US)

(72) Inventor: Nikolai L. Dobrescu, Ely, NV (US)

(21) Appl. No.: 13/886,569

(22) Filed: May 3, 2013

(51) Int. Cl. B60J 1/20

(52) U.S. Cl. CPC B60J 1/20
USPC 160/103

(57) ABSTRACT

An apparatus for covering an open portion of a window in a vehicle while enabling an optical device to extend therethrough. The apparatus includes a membrane with a periphery that is proportioned to cover the open portion of the window. Plural fasteners are located around the periphery of the membrane, which releasably engage the vehicle so as to retain the membrane in position about the open portion of the window. This shields against the intrusion of weather and provides visual privacy. There is an access port through the membrane, for insertion of the optical device therethrough. The access port provides for directional movement of the optical device, while substantially maintaining the shield against the intrusion of weather.

### BACKGROUND OF THE INVENTION

1. Field of the Invention

The present invention relates to the use of optical devices from within vehicles. More particularly, the present invention relates to the shielding of weather and light when an optical device is pointed out of an open window in a vehicle.

2. Description of the Related Art

The use of optical devices from within vehicles is known, and in fact there are a number of applications for such activity, including the use of spotting scopes, telescopes, cameras, binoculars, hunting scopes, and night vision instruments. Due to the configuration and length of such optical devices, and the desire of users of achieve high optical performance, users commonly open the vehicle window and direct the objective lens of such optical devices outwardly through the window opening. The optical device can then be pointed in the desired direction, and moved about at will as the user sits in the vehicle seat, or is otherwise located within the vehicle. There are also a variety of optical device mounts available for users to steady the instruments during use, which are also useful in a vehicle application. Examples of these include window mounts, clamps and brackets, monopods, tripods, gyroscopic stabilizers, and the like.

Directing an optical device out an open vehicle window does carry certain disadvantages. An open window exposes the interior of the vehicle to whatever local weather conditions exist. This is particularly problematic in cold weather and where there is precipitation. Wind is also a factor. In addition, there are applications where visual issues arise. For example, in the case of wildlife observation, the open window enables animals to notice the viewer, and may cause them to be wary or frighten them away. Certain surveillance applications present similar issues. In addition, the view out the window causes the user of the optical device to close the eye not peering through the optic. Therefore, it is desirable to minimize visual access while employing optical devices from within a vehicle. Thus it can be appreciated that there is a need in the art for an apparatus to address the issues that arise when optical devices are employed from with a vehicle.

### SUMMARY OF THE INVENTION

The need in the art is addressed by the apparatus of the present invention. The present disclosure teaches an apparatus for covering an open portion of a window in a vehicle while enabling an optical device to extend therethrough. The apparatus includes a membrane with a periphery that is proportioned to cover the open portion of the window. Plural fasteners are located around the periphery of the membrane, which releasably engage the vehicle so as to retain the membrane in position about the open portion of the window. This shields against the intrusion of weather and provides visual privacy. There is an access port through the membrane, for insertion of the optical device therethrough. The access port provides for directional movement of the optical device, while substantially maintaining the shield against the intrusion of weather.

In a specific embodiment of the foregoing apparatus, the optical device may be selected from a spotting scope, a camera lens, a telescope, binoculars, and a night vision device. In another embodiment, the membrane is polymeric sheeting. The polymeric sheeting may be provided in a roll that is unfurled prior to attachment to the vehicle window. In other embodiments, the membrane is fabric, and may be opaque.

In a specific embodiment of the foregoing apparatus, the plural fasteners include magnets. In a refinement to this embodiment, the magnets are positioned about the periphery of the membrane so as to engage a vehicle body panel, door, window frame, pillar, fender or roof panel. In another embodiment, the plural fasteners include adhesive strips. In another embodiment, the plural fasteners include attachment clips. In a refinement, the attachment clips are configured to engage one of; the top of a partially open window, a gap in a window frame, and a gap in a vehicle body seam. In another specific embodiment, the plural fasteners include hook and loop fasteners.

In a specific embodiment of the foregoing apparatus, the membrane includes a first portion and a second portion arranged with a seam there between, and the access port is located along the seam.

In a specific embodiment, the foregoing apparatus further includes an access port panel fastened to the membrane about the access port, and the access port panel is fabricated from a pliable material with a lens opening formed therethrough for sealable engaging the optical device.

In a specific embodiment of the foregoing apparatus, the access port is formed as a slit in the membrane. In another specific embodiment, the access port is formed by draping the membrane about the optical device.

The present disclosure also teaches an apparatus for covering an open portion of a window in a vehicle while enabling an optical device, such as a spotting scope or camera lens, to extend therethrough. The apparatus includes a membrane, fabricated from fabric or opaque polymeric sheeting, that has a periphery and that is proportioned to cover the open portion of the window. Plural magnets are embedded into the membrane and disposed about the periphery of the membrane for releasably engaging a vehicle body panel, door, window frame, pillar, fender or roof panel of the vehicle to thereby retain the membrane in position about the open portion of the window, and thereby shield against the intrusion of weather. There is an access port through the membrane, which has an access port panel fastened to the membrane about the access port for insertion of the optical device therethrough. The access port panel is fabricated from a pliable material with a lens opening formed therethrough for sealably engaging the optical device to allow directional movement of the optical device, while substantially maintaining the shield against the intrusion of weather.

The present disclosure also teaches a low cost, disposable, apparatus for covering an open portion of a window in a vehicle while enabling an optical device to extend therethrough. This embodiment includes a membrane fabricated from polymeric sheeting that has a periphery and that is proportioned to cover the open portion of the window. Plural adhesive strips are positioned around the periphery of the membrane for releasably engaging the vehicle to retain the membrane in position about the open portion of the window, and thereby shield against the intrusion of weather. It also includes an access port formed as a slit through the membrane, for insertion of the optical device therethrough. The access port allows for directional movement of the optical device, while substantially maintaining the shield against the intrusion of weather. In addition, the polymeric sheeting is provided in a roll that is unfurled prior to attachment to the vehicle window.

### BRIEF DESCRIPTION OF THE DRAWINGS

FIG. 1 is a side view drawing of the use of an optical device in a vehicle window according to the prior art.

FIG. 2 is a front view partial section view drawing of the use of an optical device in a vehicle window according to the prior art.

FIG. 3 is a side view drawing of a vehicle employing a window shield apparatus according to an illustrative embodiment of the present invention.

FIG. 4 is a front view drawing of a vehicle employing a window shield apparatus according to an illustrative embodiment of the present invention.

FIG. 5 is a side view drawing of a vehicle employing a window shield apparatus according to an illustrative embodiment of the present invention.

FIG. 6 is a front view drawing of a vehicle employing a window shield apparatus according to an illustrative embodiment of the present invention.

FIG. 7 is a side view drawing of a vehicle employing a window shield apparatus according to an illustrative embodiment of the present invention.

FIG. 8 is a front view drawing of a vehicle employing a window shield apparatus according to an illustrative embodiment of the present invention.

FIG. 9 is a side view drawing of a vehicle employing a window shield apparatus according to an illustrative embodiment of the present invention.

FIG. 10 is a section view drawing of a vehicle window employing a window shield apparatus according to an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope hereof, and additional fields in which the present invention would be of significant utility.

In considering the detailed embodiments of the present invention, it will be observed that the present invention resides primarily in combinations of steps to accomplish various methods or components to form various apparatus and systems. Accordingly, the apparatus and system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the disclosures contained herein.

In this disclosure, relational terms such as first and second, top and bottom, upper and lower, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a” does not, without more constraints, preclude the existence of additional identical elements in the process, method, article, or apparatus that comprises the element.

The teachings of the present disclosure provide a flexible membrane that can be releasable attached to an open vehicle window, and which provides an access port through which an optical device may be directed. Several embodiments are presented, including a very low cost disposable unit that is compact, easily deployed, and conveniently disposed of after use. Most of the embodiments provide weather and visual shielding for the user. The shielding is beneficial to the user since it makes it more comfortable to leave both eyes open, even though only one eye is used to peer through an optical device. The shielding prevents the bright light from affecting the user's vision. Various optical device mounts can be utilized in conjunction with the illustrative embodiments. The access ports of the illustrative embodiments are generally flexible in design so that the user can align and orient the optical devices as needed for the observation task at hand.

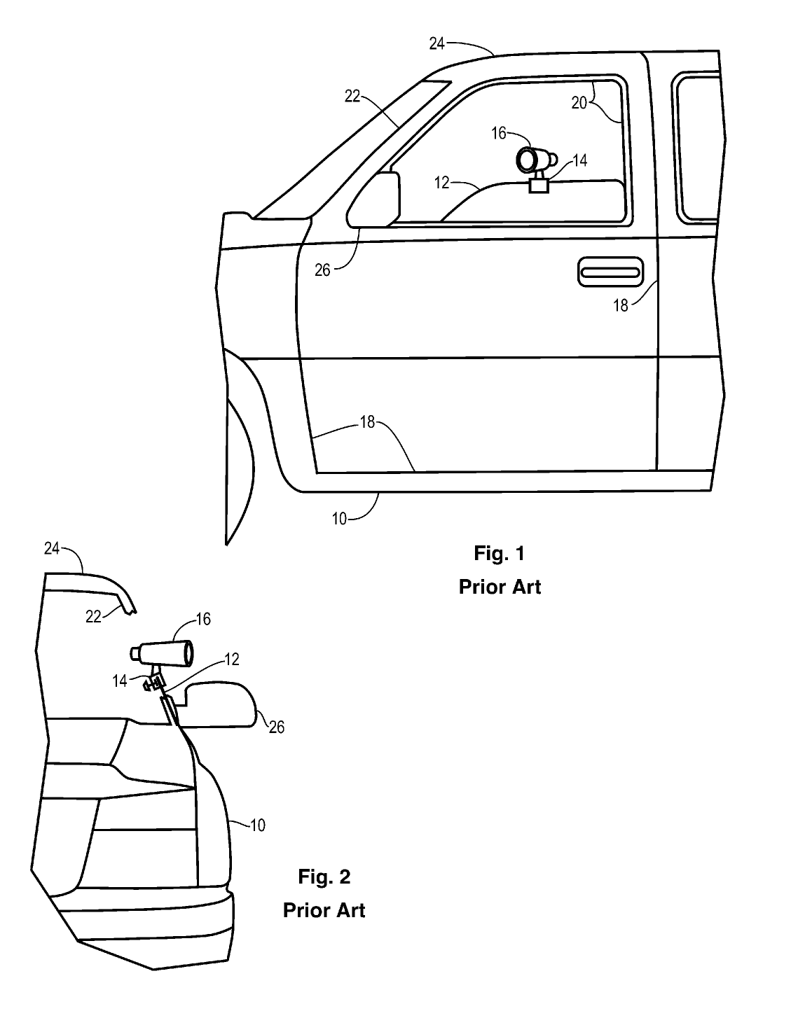

Reference is directed to FIG. 1 and FIG. 2, which are a side view drawing and a front view drawing, respectively, of the use of an optical device 16 in a vehicle window according to the prior art. In this illustration, a typical vehicle 10, such as a pickup truck, is presented. The vehicle 10 includes a door 18 having a window frame 20 and a moveable window 12, which is illustrated in a partially open condition. A pillar 22 of the vehicle extends upwardly to the roof 24 of the vehicle 10. An external rear view mirror 26 on the forward portion of the door 18 is illustrated, as this is a common vehicle configuration. An optic device mount 14 is clamped to the top of the open window 12, and supports the optical device 16, which is a spotting scope in this embodiment. It is to be understood that the other aforementioned optical devices could readily be employed, as well as the use of other mounting devices or handheld use. Of course, other vehicle types are similarly used as platforms for the use of optical devices.

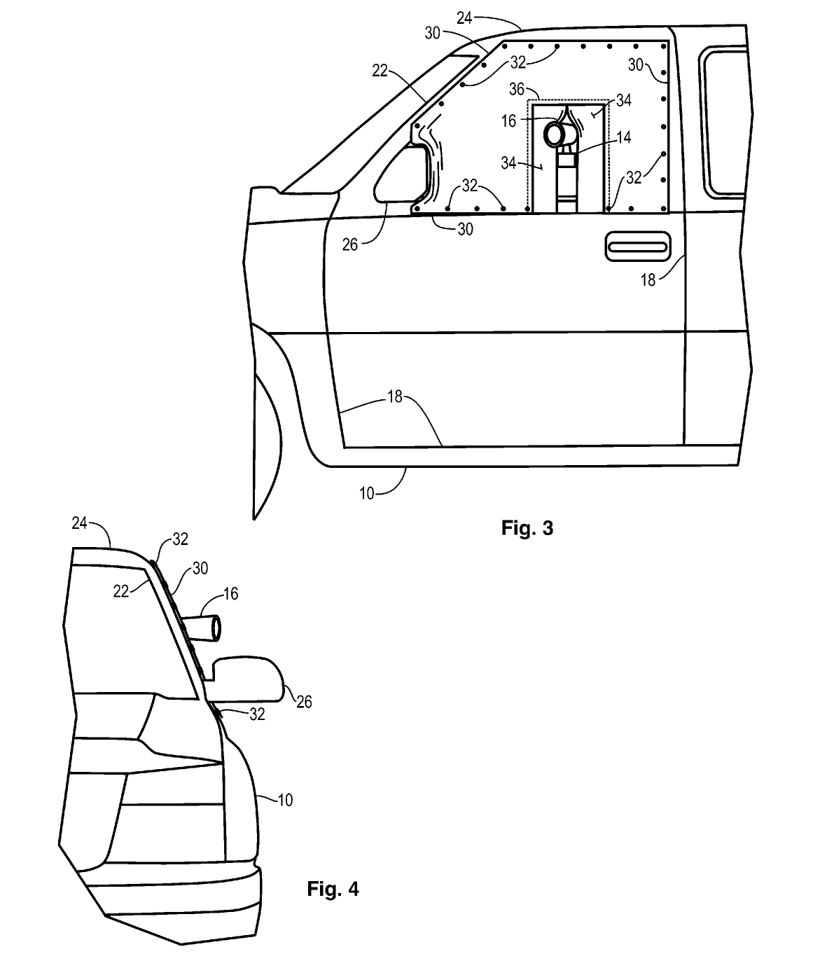

Reference is directed to FIG. 3 and FIG. 4, which are is a side view drawing and a front view drawing, respectively, of a vehicle 10 employing a window shield apparatus according to an illustrative embodiment of the present invention. The illustrative embodiment is in use with the aforementioned vehicle 10, having a door 18 with rear view mirror 26. The door 18 closes at the ‘A-pillar’ 22, which connects to the vehicle's roof 24. The apparatus of this embodiment consist of a membrane 30 that is covering the window (not shown) that is partially open while enabling an optical device 16, which is a spotting scope, to look out of the vehicle 10. Note that the spotting scope 16 is supported on a window mount 14, such that the spotting scope 16 extends out the window opening. The membrane 30 can be fabricated from fabric or opaque polymeric sheeting in this embodiment. The membrane 30 serves as a weather shield and also provides visual privacy. The membrane 30 is sized with sufficient proportions such that its periphery covers the entire window opening (not shown) to overlap onto the door 18, the A-pillar 22, and the roof 24. Plural magnets 32 are embedded into the membrane 30 and disposed about its periphery to releasably engage the vehicle body panels, thereby retaining the membrane 30 in position. In the case of a fabric membrane, the magnets 32 can be sewn into position. In the case of a polymeric membrane, the magnets 32 can be sealed into the material using a heat-sealing processes.

The membrane 30 in this embodiment includes an access port 36 through the membrane, which has an access port panel 34 fastened to the membrane 30 about the access port 36. The access port panel 34 is made from a pliable material, such as synthetic rubber, which is useful for insertion of the optical device 16 therethrough. In this embodiment, the access port panel 34 is split down the center and is pushed to the sides by the spotting scope 16. This arrangement generally provides a sealing action to engage the optical device 16 while allowing directional movement of the optical device 16, while substantially maintaining the shield against the intrusion of weather.

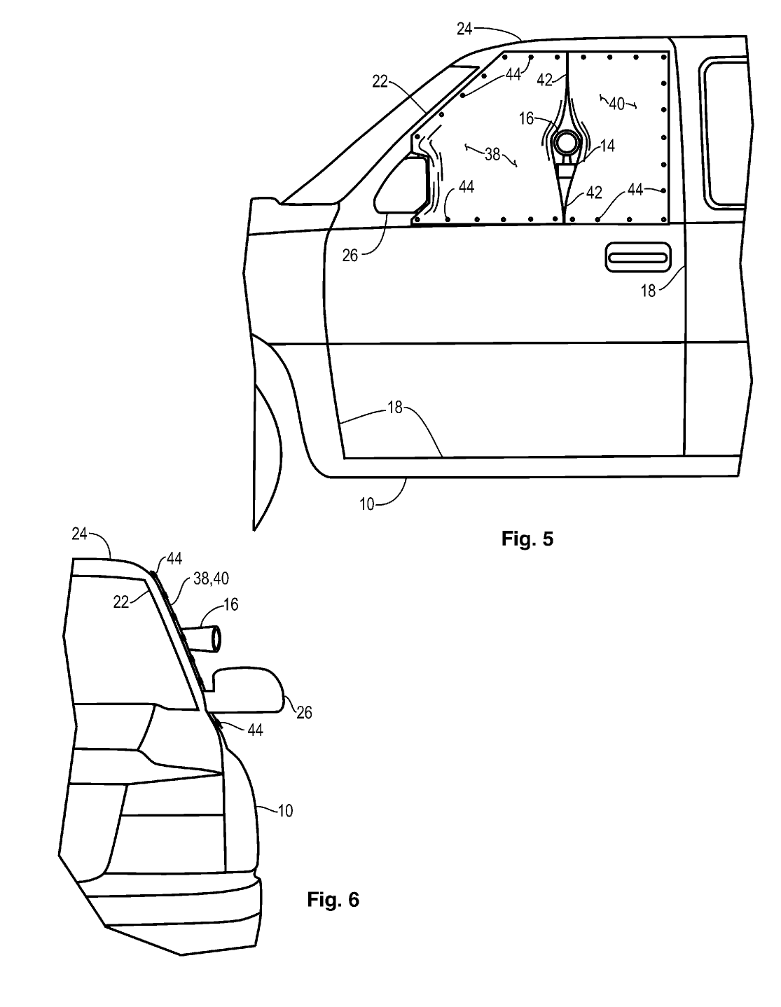

Reference is directed to FIG. 5 and FIG. 6, which are a side view drawing and a front view drawing, respectively, of a vehicle employing a window shield apparatus according to an illustrative embodiment of the present invention. In this embodiment, a membrane 38 is affixed to the vehicle 10 about the partially open window (not shown) at the door 18, the A-pillar 22, and the roof 24. Plural magnets 44 are embedded around the membrane's periphery. The magnets 44 adhere to the metal body panels. This membrane 44 is split 42 down the center, which provides an access port through which the optical device 16 is placed. Again, the optical device is supported on a window mount 14. It will be appreciated that the optical device 16 could be supported by some other type of mount, or it could be handheld by the user. In this embodiment, the split 42 in the membrane 40 wraps about the optical device 16 to maintain the desired weather shield. In addition, adjusting the position of the magnets 44 enables the user to vary the degree of overlap at the split 42. This controls the amount of weather sealing action and also allows the user to adjust the overall size of the membrane 38 to accommodate differing sizes of vehicle windows. Various flexible or pliable materials can be used as the membrane 40, such as woven fabrics, nylon, plastic sheeting, PVD, and various other polymeric sheeting types.

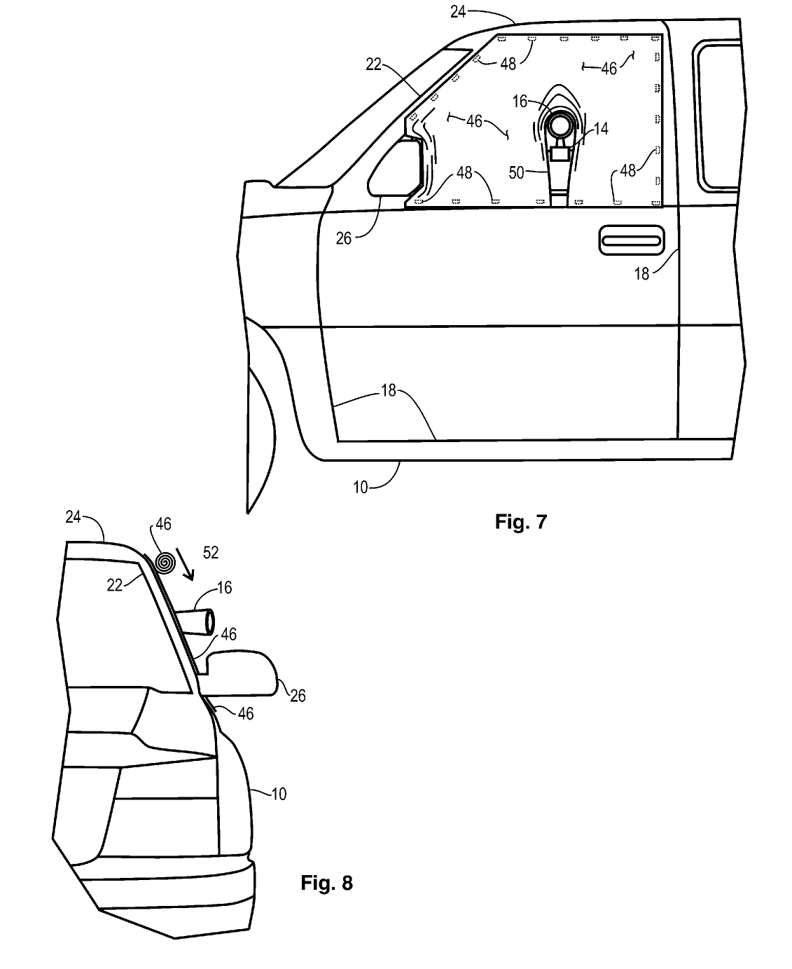

Reference is directed to FIG. 7 and FIG. 8, which are a side view drawing and a front view drawing, respectively, of a vehicle 10 employing a window shield apparatus according to an illustrative embodiment of the present invention. This embodiment presents a low cost, disposable embodiment of the present invention. Again, the membrane 46 is applied to an open, or partially open, window (not shown) of a vehicle 18, which is fastened to the door 18, A-pillar 22, and roof 24 of the vehicle 18. The membrane 46 is fabricated from lightweight polymeric sheeting, perhaps in the 4 mil. to 8 mil. thickness range. The membrane 46 is fastened to the vehicle 10 about its periphery using plural pressure sensitive adhesive strips 48, as are known in the art. The adhesive strips 48 are supplied with a peel-away cover so the user can activate the adhesive at the time the membrane 46 is applied to the vehicle 10. Since the membrane 46 is lightweight and very flexible, the access port 50 is formed by simply draping the membrane 46 over the optical device 16 and mount 14, drawing it all the way down to the door panel 18 where the adhesive strips 48 hold it in place. The adhesive is selected to be releasable, but without leaving any undesirable residue on the vehicle surface. The membrane 46 is supplied in a roll, or folded neatly, so that the user simply unfurls 52 the membrane 46 over the window opening as the adhesive strips 48 are activated and pressed against the vehicle panels.

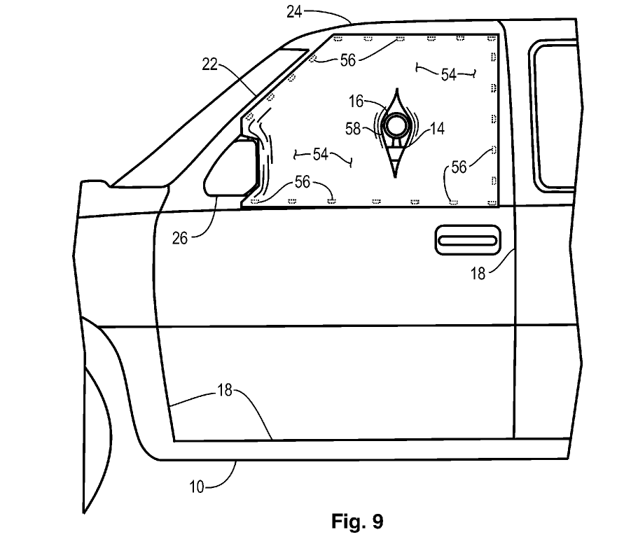

Reference is directed to FIG. 9, which is a side view drawing of a vehicle 10 employing a window shield apparatus according to an illustrative embodiment of the present invention. In this embodiment, the membrane 54 is fasted to the vehicle 10 about the door panel 18, the A-pillar 22 and the roof 24 using plural fasteners 56 that are disposed about the periphery of the membrane 54. Various types of fasteners can be employed, including the aforementioned magnets and adhesive strips, and further including other fastener types, such as hook and loop fasteners, snaps, buttons, and other fasteners known to those skilled in the art to be suitable for vehicular use. In this embodiment, the access port 58 for the optical device 16 is formed as a simple slit 58 in the membrane material 54. This is a good low cost alternative design approach. Note that the membrane 54 is flexible enough to stretch and wrap about the optical device 16, as well as the rear view mirror 26 and any other fixtures that may be present on a typical vehicle.

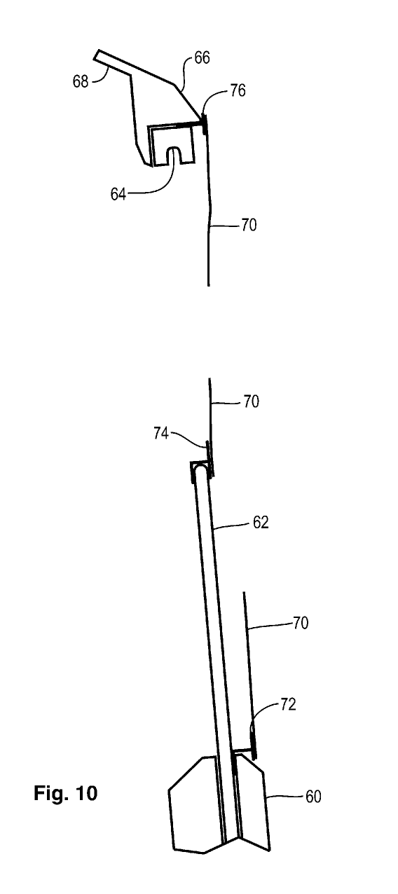

Reference is directed to FIG. 10, which is a section view drawing of a vehicle window assembly employing a window shield apparatus according to an illustrative embodiment of the present invention. This embodiment discloses alternative fastening techniques that are suitable for use with the present invention. This section view illustrates a vehicle door 60 with a roll-up window 62, which closes against a window frame 64 at the top. The window frame 64 closes against a door jamb 66 that connects to the vehicle roof 68. The membrane 70 is connected to several types of fastener clips. The door clip 72 advantageously engages the gap between the door 60 and the window 62. The window top clip 74 advantageously fastens to the top edge of the window 62. The header clip 76 advantageously engages the gap between the window frame 64 and the door jamb 66. All of these clips 72, 74, 76 are molded or extruded to a suitable size and shape to engage the vehicle. They can be adhesively or thermally bonded to the membrane material 70.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. An apparatus for covering an open portion of a window in a vehicle while enabling an optical device to extend therethrough, comprising:
a membrane having a periphery and proportioned to cover the open portion of the window;
plural fasteners disposed about said periphery of said membrane for releasably engaging the vehicle to retain said membrane in position about the open portion of the window, and thereby shield against the intrusion of weather, and
an access port through said membrane, for insertion of the optical device therethrough, said access port enabled to allow directional movement of the optical device, while substantially maintaining the shield against the intrusion of weather.

2. The apparatus of claim 1, and wherein the optical device is selected from a spotting scope, a camera lens, a telescope, binoculars, and a night vision device.

3. The apparatus of claim 1, and wherein:
said membrane is polymeric sheeting.

4. The apparatus of claim 3, and wherein:
said polymeric sheeting is provided in a roll that is unfurled prior to attachment to the vehicle window.

5. The apparatus of claim 1, and wherein:
said membrane is fabric.

6. The apparatus of claim 1, and wherein:
said membrane is opaque.

7. The apparatus of claim 1, and wherein:
said plural fasteners comprise magnets.

8. The apparatus of claim 7, and wherein:
said magnets are positioned about said periphery to engage a vehicle body panel, door, window frame, pillar, fender or roof panel.

9. The apparatus of claim 1, and wherein:
said plural fasteners comprise adhesive strips.

10. The apparatus of claim 1, and wherein:
said plural fasteners comprise attachment clips.

11. The apparatus of claim 10, and wherein:
said attachment clips are configured to engage one of; the top of a partially open window, a gap in a window frame, and a gap in a vehicle body seam.

12. The apparatus of claim 1, and wherein:
said plural fasteners comprise hook and loop fasteners.

13. The apparatus of claim 1, and wherein:
said membrane includes a first portion and a second portion arranged with a seam there between, and wherein
said access port is located along said seam.

14. The apparatus of claim 1, further comprising:
an access port panel fastened to said membrane about said access port, and wherein
said access port panel is fabricated from a pliable material with a lens opening formed therethrough for sealable engaging the optical device.

15. The apparatus of claim 1, and wherein:
said access port is formed as a slit in said membrane.

16. The apparatus of claim 1, and wherein:
said access port is formed by draping said membrane about the optical device.

17. An apparatus for covering an open portion of a window in a vehicle while enabling an optical device, such as a spotting scope or camera lens, to extend therethrough, comprising:
a membrane, fabricated from fabric or opaque polymeric sheeting, having a periphery and proportioned to cover the open portion of the window;
plural magnets embedded into said membrane and disposed about said periphery of said membrane for releasably engaging a vehicle body panel, door, window frame, pillar, fender or roof panel of the vehicle to thereby retain said membrane in position about the open portion of the window, and thereby shield against the intrusion of weather;
an access port through said membrane, having an access port panel fastened to said membrane about said access port, and wherein
said access port panel is fabricated from a pliable material with a lens opening formed therethrough for sealably engaging the optical device to allow directional movement of the optical device, while substantially maintaining the shield against the intrusion of weather.

18. A low cost, disposable, apparatus for covering an open portion of a window in a vehicle while enabling an optical device to extend therethrough, comprising:
a membrane fabricated from polymeric sheeting having a periphery and proportioned to cover the open portion of the window;
plural adhesive strips disposed about said periphery of said membrane for releasably engaging the vehicle to retain said membrane in position about the open portion of the window, and thereby shield against the intrusion of weather, and
an access port formed as a slit through said membrane, for insertion of the optical device therethrough, said access port enabled to allow directional movement of the optical device, while substantially maintaining the shield against the intrusion of weather, and wherein
said polymeric sheeting is provided in a roll that is unfurled prior to attachment to the vehicle window.
